(19) United States
(12) Patent Application Publication
(10) Pub. No.: US 2020/0300650 A1
(43) Pub. Date: Sep. 24, 2020

(54) SYSTEMS AND METHODS FOR DETERMINING AN ESTIMATED TIME OF ARRIVAL FOR ONLINE TO OFFLINE SERVICES

(71) Applicant: BEIJING DIDI INFINITY TECHNOLOGY AND DEVELOPMENT CO., LTD., Beijing (CN)

(72) Inventor: Junqin LI, Beijing (CN)

(73) Assignee: BEIJING DIDI INFINITY TECHNOLOGY AND DEVELOPMENT CO., LTD., Beijing (CN)

(21) Appl. No.: 16/893,622

(22) Filed: Jun. 5, 2020

Related U.S. Application Data
(63) Continuation of application No. PCT/CN2018/088341, filed on May 25, 2018.

(30) Foreign Application Priority Data
Dec. 5, 2017 (CN) 201711268624.1

(51) Int. Cl. G01C 21/34; G06N 3/08; G06Q 10/02; G06Q 50/30; G01C 21/36

(52) U.S. Cl. CPC G01C 21/3492; G06N 3/08; G01C 21/3691; G06Q 50/30; G06Q 10/02

(57) ABSTRACT

A system includes one or more storage medium storing a set of instructions and at least one processor in communication with the storage device. When executing the instructions, the at least one processor is configured to cause the system to obtain first information related to a potential service order initiated by a target requester terminal, and obtain second information related to one or more candidate service providers within a threshold distance from the start location. The at least one processor may also cause the system to determine an ETA for the potential service order by inputting the first information and the second information into a trained neural network model of ETA. The at least one processor may further cause the system to transmit, to the target requester terminal, the ETA of the potential service order for display.

### CROSS-REFERENCE TO RELATED APPLICATION

This application is a Continuation of International Application No. PCT/CN2018/088341, filed on May 25, 2018, which claims priority of Chinese Patent Application No. 201711268624.1, filed on Dec. 5, 2017, the contents of which are entirely incorporated herein by reference.

### TECHNICAL FIELD

The present disclosure generally relates to Online to Offline (O2O) service platforms, and in particular, to systems and methods for determining an estimated time of arrival (ETA) in an online O2O service platform.

### BACKGROUND

With the development of Internet technology, O2O services, such as online taxi hailing services and delivery services, play a more and more significant role in people's daily lives. For example, online taxi-hailing services have been heavily used by passengers. When a passenger hails a taxi at a start location, he/her may want to know an estimated time for a service provider to arrive at the start location, which is referred to as an ETA for brevity herein. The ETA may be affected by various factors, such as the number of available service providers around the start location, the distances between the available service providers and the start location, the traffic condition, the weather condition, the supply-demand relationship around the start location, etc. Without considering these various factors, the ETA may not be determined precisely and accurately. Thus, it is desirable to develop effective systems and methods to determine an ETA in online O2O service platforms by taking into consideration one or more factors that may affect the ETA.

### SUMMARY

In one aspect of the present disclosure, a system is provided. The system may include at least one non-transitory computer-readable storage medium and at least one processor in communication with the at least one non-transitory computer-readable storage medium. The non-transitory computer-readable storage medium may include a set of instructions for determining an ETA. When executing the set of instructions, the at least one processor may be directed to cause the system to obtain first information related to a potential service order initiated by a target requester terminal. The first information may include a start location of the potential service order. The at least one processor may be directed to cause the system to obtain second information related to one or more candidate service providers within a threshold distance from the start location. At least part of the second information may indicate a possibility for each of the one or more candidate service providers becoming a target service provider of the potential service order. The at least one processor may be also directed to cause the system to determine an ETA for the potential service order by inputting the first information and the second information into a trained neural network model of ETA. The at least one processor may be further directed to cause the system to transmit the ETA of the potential service order to the target requester terminal for display.

In some embodiments, to obtain the second information related to the one or more candidate service providers, the at least one processor may be directed to cause the system to determine the one or more candidate service providers within the threshold distance from the start location. The at least one processor may be directed to cause the system to determine one or more potential requester terminals within the threshold distance from the start location, and pre-allocate the one or more candidate service providers to the one or more potential requester terminals and the target requester terminal. The at least one processor may be further directed to cause the system to determine the possibility for each of the one or more candidate service providers becoming the target service provider of the potential service order based on the pre-allocation result.

In some embodiments, to determine the ETA for the potential service order, the at least one processor may be directed to cause the system to obtain demand information related to one or more potential requester terminals within the threshold distance from the start location. The at least one processor may be also directed to cause the system to determine the ETA for the potential service order by inputting the first information, the second information, and the demand information into the trained neural network model of ETA.

In some embodiments, the demand information may include at least one of time information, location information, service order information, or user information related to the one or more potential requester terminals.

In some embodiments, the first information may further include at least one of time information, location information, weather information, traffic information, policy information, news information, or user information related to the potential service order.

In some embodiments, the second information may further include at least one of vehicle information, capacity information, price information, service information, location information, or performance information related to the one or more candidate service providers.

In some embodiments, the trained neural network model of ETA may be generated according to a training process, and the training process may include obtaining third information related to the sample potential service order for each of a plurality of sample potential service orders. The third information may include a sample start location of the sample potential service order. The training process may also include obtaining fourth information related to one or more sample candidate service providers within a sample threshold distance from the corresponding sample start location for each of the plurality of sample potential service orders. At least part of the fourth information may indicate a sample possibility for each of the one or more sample candidate service providers becoming a sample target service provider of the sample potential service order. The training process may further include obtaining a preliminary neural network model and generating the trained neural network model of ETA by training the preliminary neural network model using the third information and the fourth information of the plurality of sample potential service orders.

In some embodiments, the generating the trained neural network model of ETA may include obtaining sample demand information related to one or more sample potential requester terminals within the threshold distance from the corresponding sample start location for each of the plurality of sample potential service orders. The generating the trained neural network model of ETA may further include determining the trained neural network model of ETA by training the preliminary neural network model using the third information, the fourth information, and the sample demand information of each of the plurality of sample potential service orders.

In some embodiments, the determining the trained neural network model of ETA may include (1) training the preliminary neural network model by the third information and the fourth information corresponding to a first portion of the plurality of sample potential service orders. The determining the trained neural network model of ETA may further include (2) testing the trained preliminary neural network model with the third information and the fourth information corresponding to a second portion of the plurality of sample potential service orders by determining a test parameter. The determining the trained neural network model of ETA may further include repeating steps (1)-(2) upon a determination that the test parameter is more than or equal to the test threshold, or designating the trained preliminary neural network model as the trained neural network model of ETA upon a determination that the test parameter is less than the test threshold.

In some embodiments, the training the preliminary neural network model by the third information and the fourth information corresponding to the first portion of the plurality of sample potential service orders may include, for each of the first portion of the plurality of sample potential service orders, obtaining an actual time of arrival (ATA) of the sample potential service order and determining a predicted ETA by inputting the third information and the fourth information of the sample potential service order into the preliminary neural network model. The training the preliminary neural network model by the third information and the fourth information corresponding to the first portion of the plurality of sample potential service orders may also include determining a loss function based on the predicted ETAs and the ATAs of the first portion of sample potential service orders, and determining whether the loss function is less than a training threshold. The training the preliminary neural network model by the third information and the fourth information corresponding to the first portion of the plurality of sample potential service orders may further include designating the preliminary neural network model as the trained preliminary neural network model upon a determination that the loss function is less than the training threshold, or updating the preliminary neural network model in response to a determination that the loss function is not less than the training threshold.

In another aspect of the present disclosure, a method is provided. The method may be implemented on a computing device having at least one processor, at least one computer-readable storage medium, and a communication platform connected to a network. The method may include obtaining first information related to a potential service order initiated by a target requester terminal. The first information may include a start location of the potential service order. The method may include obtaining second information related to one or more candidate service providers within a threshold distance from the start location. At least part of the second information may indicate a possibility for each of the one or more candidate service providers becoming a target service provider of the potential service order. The method may also include determining an ETA for the potential service order by inputting the first information and the second information into a trained neural network model of ETA. The method may further include transmitting the ETA of the potential service order to the target requester terminal for display.

In another aspect of the present disclosure, a non-transitory computer-readable storage medium may include a set of instructions. When the set of instructions is executed by at least one processor, the set of instructions may cause the system to perform a method. The method may include obtaining first information related to a potential service order initiated by a target requester terminal. The first information may include a start location of the potential service order. The method may include obtaining second information related to one or more candidate service providers within a threshold distance from the start location. At least part of the second information may indicate a possibility for each of the one or more candidate service providers becoming a target service provider of the potential service order. The method may also include determining an ETA for the potential service order by inputting the first information and the second information into a trained neural network model of ETA. The method may further include transmitting the ETA of the potential service order to the target requester terminal for display.

In yet another aspect of the present disclosure, a system is provided. The system may include an obtaining module, a determination module, and a transmission module. The obtaining module may be configured to obtain first information related to a potential service order initiated by a target requester terminal, and obtain second information related to one or more candidate service providers within a threshold distance from the start location. The first information may include a start location of the potential service order. At least part of the second information may indicate a possibility for each of the one or more candidate service providers becoming a target service provider of the potential service order. The determination module may be configured to determine an ETA for the potential service order by inputting the first information and the second information into a trained neural network model of ETA. The transmission module may be configured to transmit the ETA of the potential service order to the target requester terminal for display.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a block diagram illustrating an exemplary O2O service system according to some embodiments of the present disclosure;

FIG. 2 is a schematic diagram illustrating exemplary hardware and software components of an exemplary computing device according to some embodiments of the present disclosure;

FIG. 3 is a schematic diagram illustrating exemplary hardware and/or software components of an exemplary mobile device on which a use terminal may be implemented according to some embodiments of the present disclosure;

FIGS. 4A and 4B are block diagrams respectively illustrating exemplary processing engines according to some embodiments of the present disclosure.

FIG. 5 is a flowchart illustrating an exemplary process for determining an ETA for O2O services according to some embodiments of the present disclosure;

FIG. 6 is a flowchart illustrating an exemplary process for determining a possibility for a candidate service provider becoming a target service provider of a potential service order according to some embodiments of the present disclosure; and

FIG. 7 is a flowchart illustrating an exemplary process for determining a trained neural network model of ETA according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is to describe particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the system and method in the present disclosure is described primarily in regard to distributing a request for a transportation service, it should also be understood that the present disclosure is not intended to be limiting. The system or method of the present disclosure may be applied to any other kind of O2O service. For example, the system or method of the present disclosure may be applied to transportation systems of different environments including land, ocean, aerospace, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, or the like, or any combination thereof. The transportation system may also include any transportation system for management and/or distribution, for example, a system for sending and/or receiving an express. The application of the system or method of the present disclosure may be implemented on a user device and include a webpage, a plug-in of a browser, a client terminal, a custom system, an internal analysis system, an artificial intelligence robot, or the like, or any combination thereof.

The term “passenger,” “requester,” “service requester,” and “customer” in the present disclosure are used interchangeably to refer to an individual, an entity, or a tool that may request or order a service. Also, the term “driver,” “provider,” and “service provider” in the present disclosure are used interchangeably to refer to an individual, an entity, or a tool that may provide a service or facilitate the providing of the service.

The term “service request,” “request for a service,” “requests,” and “order” in the present disclosure are used interchangeably to refer to a request that may be initiated by a passenger, a service requester, a customer, a driver, a provider, a service provider, or the like, or any combination thereof. The service request may be accepted by any one of a passenger, a service requester, a customer, a driver, a provider, or a service provider. The service request may be chargeable or free.

The term “service provider terminal” and “driver terminal” in the present disclosure are used interchangeably to refer to a mobile terminal that is used by a service provider to provide a service or facilitate the providing of the service. The term “service requester terminal” and “passenger terminal” in the present disclosure are used interchangeably to refer to a mobile terminal that is used by a service requester to request or order a service.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

An aspect of the present disclosure relates to systems and methods for determining an ETA in an online O2O service platform. The ETA, which refers to an estimated time for a service provider to arrive at a start location of a service order, may be affected by various factors. These factors may be needed to be taken into consideration in the determination of the ETA. According to the present disclosure, the systems and methods may obtain first information related to a potential service order initiated by a target requester terminal. The first information may include a start location of the potential service order. The systems and methods may also obtain second information related to one or more candidate service providers within a threshold distance from the start location. At least part of the second information may indicate a possibility for each candidate service provider becoming a target service provider of the potential service order. In some embodiments, the systems and methods may further obtain demand information related to one or more potential requester terminals within the threshold distance from the start location. Then, the systems and methods may determine the ETA of the potential service order by inputting the first information, the second information, and optionally the demand information into the trained neural network model of ETA. As such, the ETA of the potential service order may be determined more accurately and efficiently.

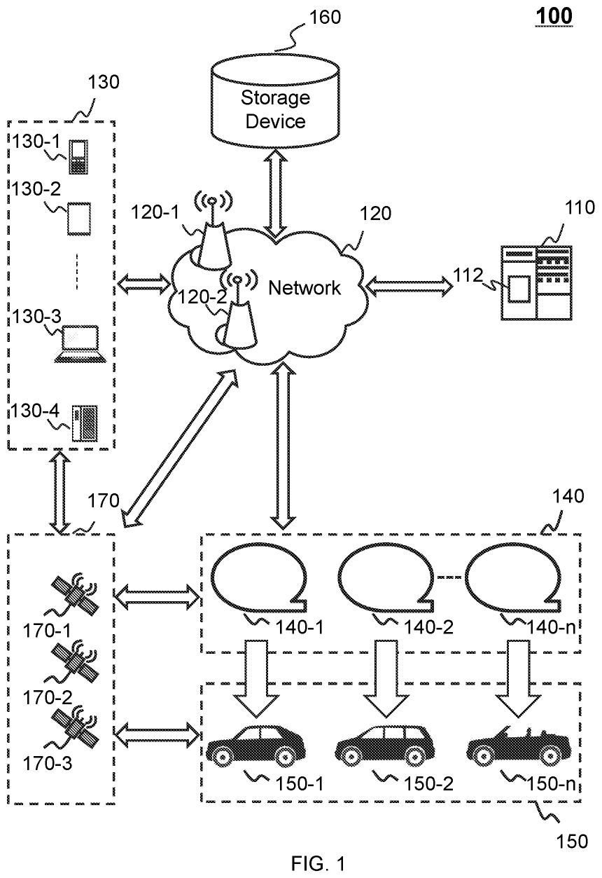

FIG. 1 is a block diagram illustrating an exemplary O2O service system 100 according to some embodiments of the present disclosure. For example, the O2O service system 100 may be an online transportation service platform for transportation services, an online delivery service platform for meal delivery services, etc. The O2O service system 100 may include a server 110, a network 120, a service requester terminal 130, a service provider terminal 140, a vehicle 150, a storage device 160, and a navigation system 170.

The O2O service system 100 may provide a plurality of services. Exemplary service may include a taxi-hailing service, a chauffeur service, an express car service, a carpool service, a bus service, a driver hire service, and a shuttle service. In some embodiments, the O2O service may be any on-line service, such as booking a meal, shopping, or the like, or any combination thereof.

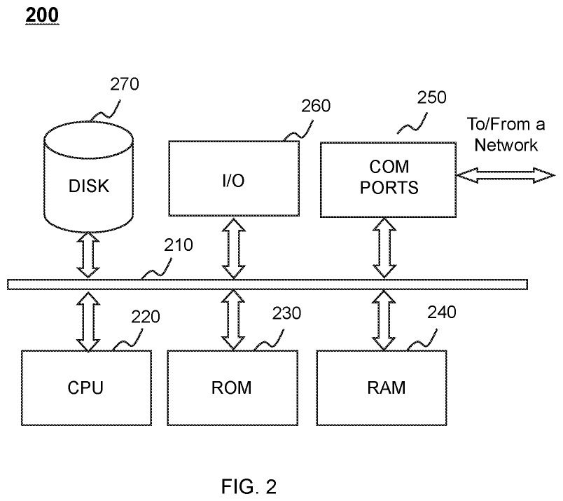

In some embodiments, the server 110 may be a single server or a server group. The server group may be centralized, or distributed (e.g., the server 110 may be a distributed system). In some embodiments, the server 110 may be local or remote. For example, the server 110 may access information and/or data stored in the service requester terminal 130, the service provider terminal 140, and/or the storage device 160 via the network 120. As another example, the server 110 may be directly connected to the service requester terminal 130, the service provider terminal 140, and/or the storage device 160 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data related to the service request to perform one or more functions described in the present disclosure. For example, the processing engine 112 may determine an ETA for a service order. As another example, the processing engine 112 may generate a trained neural network model of ETA. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components of the O2O service system 100 (e.g., the server 110, the service requester terminal 130, the service provider terminal 140, the vehicle 150, the storage device 160, and the navigation system 170) may transmit information and/or data to other component(s) of the O2O service system 100 via the network 120. For example, the server 110 may receive a service request from the service requester terminal 130 via the network 120. In some embodiments, the network 120 may be any type of wired or wireless network, or combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the O2O service system 100 may be connected to the network 120 to exchange data and/or information.

In some embodiments, a passenger may be an owner of the service requester terminal 130. In some embodiments, the owner of the service requester terminal 130 may be someone other than the passenger. For example, an owner A of the service requester terminal 130 may use the service requester terminal 130 to transmit a service request for a passenger B or receive a service confirmation and/or information or instructions from the server 110. In some embodiments, a service provider may be a user of the service provider terminal 140. In some embodiments, the user of the service provider terminal 140 may be someone other than the service provider. For example, a user C of the service provider terminal 140 may use the service provider terminal 140 to receive a service request for a service provider D, and/or information or instructions from the server 110. In some embodiments, “passenger” and “passenger terminal” may be used interchangeably, and “service provider” and “service provider terminal” may be used interchangeably. In some embodiments, the service provider terminal may be associated with one or more service providers (e.g., a night-shift service provider, or a day-shift service provider).

In some embodiments, the service requester terminal 130 may include a mobile device 130-1, a tablet computer 130-2, a laptop computer 130-3, a built-in device in a vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, smart glasses, a smart helmet, a smart watch, smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, augmented reality glasses, an augmented reality patch, or the like, or any combination thereof. For example, the virtual reality device and/or the augmented reality device may include a Google™ Glass, an Oculus Rift, a HoloLens, a Gear VR, etc. In some embodiments, the built-in device in the vehicle 130-4 may include an onboard computer, an onboard television, etc. In some embodiments, the service requester terminal 130 may be a device with positioning technology for locating the position of the passenger and/or the service requester terminal 130.

The service provider terminal 140 may include a plurality of service provider terminals 140-1, 140-2, . . . , 140-n. In some embodiments, the service provider terminal 140 may be similar to, or the same device as the service requester terminal 130. In some embodiments, the service provider terminal 140 may be customized to be able to implement the online on-demand transportation service. In some embodiments, the service provider terminal 140 may be a device with positioning technology for locating the service provider, the service provider terminal 140, and/or a vehicle 150 associated with the service provider terminal 140. In some embodiments, the service requester terminal 130 and/or the service provider terminal 140 may communicate with another positioning device to determine the position of the passenger, the service requester terminal 130, the service provider, and/or the service provider terminal 140. In some embodiments, the service requester terminal 130 and/or the service provider terminal 140 may periodically transmit the positioning information to the server 110. In some embodiments, the service provider terminal 140 may also periodically transmit the availability status to the server 110. The availability status may indicate whether a vehicle 150 associated with the service provider terminal 140 is available to carry a passenger. For example, the service requester terminal 130 and/or the service provider terminal 140 may transmit the positioning information and the availability status to the server 110 every thirty minutes. As another example, the service requester terminal 130 and/or the service provider terminal 140 may transmit the positioning information and the availability status to the server 110 each time the user logs into the mobile application associated with the online on-demand transportation service.

In some embodiments, the service provider terminal 140 may correspond to one or more vehicles 150. The vehicles 150 may carry the passenger and travel to the destination. The vehicles 150 may include a plurality of vehicles 150-1, 150-2, . . . , 150-n. One vehicle may correspond to one type of services (e.g., a taxi-hailing service, a chauffeur service, an express car service, a carpool service, a bus service, a driver hire service, or a shuttle service).

The storage device 160 may store data and/or instructions. In some embodiments, the storage device 160 may store data obtained from the service requester terminal 130 and/or the service provider terminal 140. In some embodiments, the storage device 160 may store data and/or instructions that the server 110 may execute or use to perform exemplary methods described in the present disclosure. In some embodiments, storage device 160 may include a mass storage, removable storage, a volatile read-and-write memory, a read-only memory (ROM), or the like, or any combination thereof. Exemplary mass storage may include a magnetic disk, an optical disk, solid-state drives, etc. Exemplary removable storage may include a flash drive, a floppy disk, an optical disk, a memory card, a zip disk, a magnetic tape, etc. Exemplary volatile read-and-write memory may include a random-access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 160 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 160 may be connected to the network 120 to communicate with one or more components of the O2O service system 100 (e.g., the server 110, the service requester terminal 130, or the service provider terminal 140). One or more components of the O2O service system 100 may access the data or instructions stored in the storage device 160 via the network 120. In some embodiments, the storage device 160 may be directly connected to or communicate with one or more components of the O2O service system 100 (e.g., the server 110, the service requester terminal 130, the service provider terminal 140). In some embodiments, the storage device 160 may be part of the server 110.

The navigation system 170 may determine information associated with an object, for example, one or more of the service requester terminal 130, the service provider terminal 140, the vehicle 150, etc. In some embodiments, the navigation system 170 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, or a current time. The navigation system 170 may include one or more satellites, for example, a satellite 170-1, a satellite 170-2, and a satellite 170-3. The satellites 170-1 through 170-3 may determine the information mentioned above independently or jointly. The satellite navigation system 170 may transmit the information mentioned above to the network 120, the service requester terminal 130, the service provider terminal 140, or the vehicle 150 via wireless connections.

In some embodiments, one or more components of the O2O service system 100 (e.g., the server 110, the service requester terminal 130, the service provider terminal 140) may have permissions to access the storage device 160. In some embodiments, one or more components of the O2O service system 100 may read and/or modify information related to the passenger, service provider, and/or the public when one or more conditions are met. For example, the server 110 may read and/or modify one or more passengers' information after a service is completed. As another example, the server 110 may read and/or modify one or more service providers' information after a service is completed.

In some embodiments, information exchanging of one or more components of the O2O service system 100 may be initiated by way of requesting a service. The object of the service request may be any product. In some embodiments, the product may include food, medicine, commodity, chemical product, electrical appliance, clothing, car, housing, luxury, or the like, or any combination thereof. In some other embodiments, the product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used on the computer or mobile phone. The software and/or application may relate to socializing, shopping, transporting, entertainment, learning, investment, or the like, or any combination thereof. In some embodiments, the software and/or application related to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

One of ordinary skill in the art would understand that when an element (or component) of the O2O service system 100 performs, the element may perform through electrical signals and/or electromagnetic signals. For example, when a service requester terminal 130 transmits out a service request to the server 110, a processor of the service requester terminal 130 may generate an electrical signal encoding the request. The processor of the service requester terminal 130 may then transmit the electrical signal to an output port. If the service requester terminal 130 communicates with the server 110 via a wired network, the output port may be physically connected to a cable, which further may transmit the electrical signal to an input port of the server 110. If the service requester terminal 130 communicates with the server 110 via a wireless network, the output port of the service requester terminal 130 may be one or more antennas, which convert the electrical signal to electromagnetic signal. Similarly, a service provider terminal 130 may receive an instruction and/or service request from the server 110 via electrical signal or electromagnet signals. Within an electronic device, such as the service requester terminal 130, the service provider terminal 140, and/or the server 110, when a processor thereof processes an instruction, transmits out an instruction, and/or performs an action, the instruction and/or action is conducted via electrical signals. For example, when the processor retrieves or saves data from a storage medium, it may transmit out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 is a schematic diagram illustrating exemplary hardware and software components of a computing device 200 on which the server 110, the service requester terminal 130, and/or the service provider terminal 140 may be implemented according to some embodiments of the present disclosure. For example, the processing engine 112 may be implemented on the computing device 200 and configured to perform functions of the processing engine 112 disclosed in this disclosure.

The computing device 200 may be a special purpose computer in some embodiments. The computing device 200 may be used to implement an O2O system for the present disclosure. The computing device 200 may implement any component of the O2O service as described herein. In FIGS. 1-2, only one such computer device is shown purely for convenience purposes. One of ordinary skill in the art would understood at the time of filing of this application that the computer functions relating to the O2O service as described herein may be implemented in a distributed fashion on a number of similar platforms, to distribute the processing load.

The computing device 200, for example, may include COM ports 250 connected to and from a network connected thereto to facilitate data communications. The computing device 200 may also include a central processing unit (CPU, or processor) 220, in the form of one or more processors, for executing program instructions. The exemplary computer platform may include an internal communication bus 210, a program storage and a data storage of different forms, for example, a disk 270, and a read only memory (ROM) 230, or a random access memory (RAM) 240, for various data files to be processed and/or transmitted by the computer. The exemplary computer platform may also include program instructions stored in the ROM 230, the RAM 240, and/or other type of non-transitory storage medium to be executed by the CPU/processor 220. The methods and/or processes of the present disclosure may be implemented as the program instructions. The computing device 200 may also include an I/O component 260, supporting input/output between the computer and other components therein such as a user interface element (not shown in FIG. 2). The computing device 200 may also receive programming and data via network communications.

Merely for illustration, only one CPU/processor 220 is described in the computing device 200. However, it should be note that the computing device 200 in the present disclosure may also include multiple CPUs/processors, thus operations and/or method steps that are performed by one CPU/processor 220 as described in the present disclosure may also be jointly or separately performed by the multiple CPUs/processors. For example, if in the present disclosure the CPU/processor 220 of the computing device 200 executes both step A and step B, it should be understood that step A and step B may also be performed by two different CPUs/processors jointly or separately in the computing device 200 (e.g., the first processor executes step A and the second processor executes step B, or the first and second processors jointly execute steps A and B).

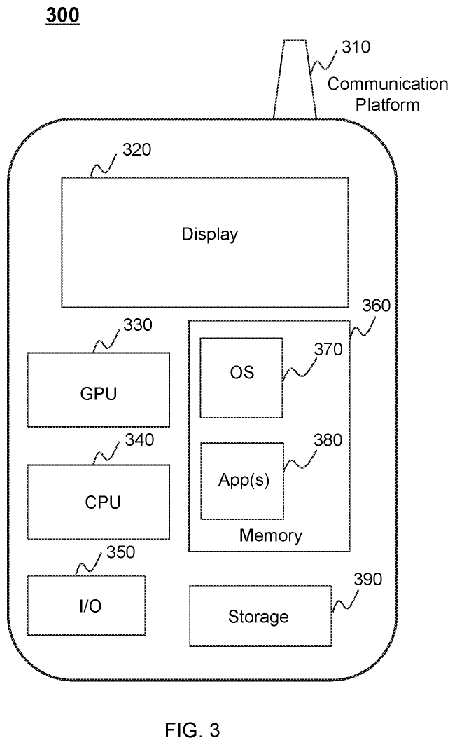

FIG. 3 is a schematic diagram illustrating exemplary hardware and/or software components of an exemplary mobile device 300 on which a user terminal may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to image processing or other information from the processing engine 112. User interactions with the information stream may be achieved via the I/O 350 and provided to the processing engine 112 and/or other components of the O2O service system 100 via the network 120.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

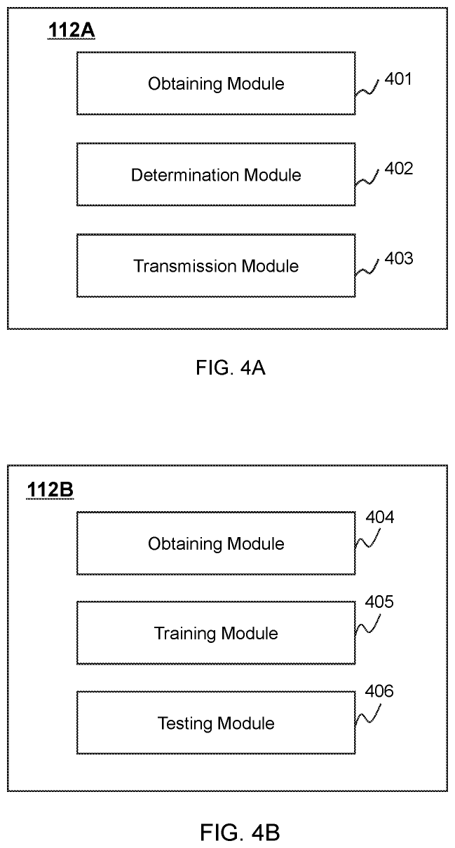

FIGS. 4A and 4B are block diagrams respectively illustrating an exemplary processing engine 112A and 112B according to some embodiments of the present disclosure. In some embodiments, the processing engine 112A may be configured to determine an ETA of a service order, and the processing engine 112B may be configured to generate a trained neural network model of ETA. In some embodiments, the processing engines 112A and 112B may respectively be implemented on a computing device 200 (e.g., the CPU 210) illustrated in FIG. 2 or a CPU 340 as illustrated in FIG. 3. Merely by way of example, the processing engine 112A may be implemented on a CPU 340 of a mobile device and the processing engine 112B may be implemented on a computing device 200. Alternatively, the processing engines 112A and 112B may be implemented on the same computing device 200 or the same CPU 340.

The processing engine 112A may include an obtaining module 401, a determination module 402, and a transmission module 403. The modules may be hardware circuits of all or part of the processing engine 112A. The modules may also be implemented as an application or set of instructions read and executed by the processing engine 112A. Further, the modules may be any combination of the hardware circuits and the application/instructions. For example, the modules may be the part of the processing engine 112A when the processing engine 112A is executing the application/set of instructions.

The obtaining module 401 may be configured to obtain information related to the O2O service system 100. For example, the obtaining module 401 may obtain first information related to a potential service order initiated by a target requester terminal, second information related to one or more candidate service providers within a threshold distance from a start location of the potential service order, demand information related to one or more potential requester terminals within the threshold distance from the start location, a trained neural network model of ETA, or the like, or any combination thereof. In some embodiments, the obtaining module 401 may obtain information from one or more components of the O2O service system 100, such as the storage device 160, the processing engine 112B, the requester terminal 130, and/or the provider terminal 140. Additionally or alternatively, the obtaining module 401 may obtain information from an external data source (not shown) via the network 120.

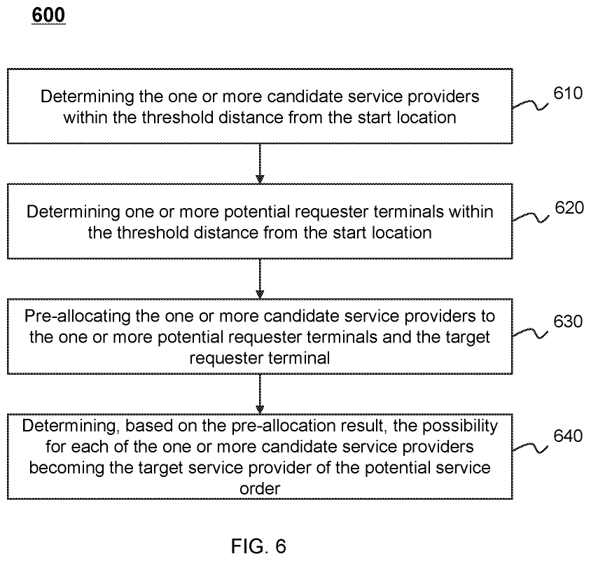

The determination module 402 may be configured to determine an ETA of the potential service order. For example, the determination module 402 may determine the ETA by inputting the first, the second, and/or the demand information related to the potential service order into a trained neural network model of ETA. In some embodiments, the determination module 402 may be further configured to determine a possibility for each candidate service provider becoming a target service provider of the potential service order. For example, the determination module 402 may determine the possibility based on various factors, such as a supply and demand relationship in the nearby area around the start location of the potential service order, the traffic rules and laws in the nearby area around the start location and/or the destination, a service region, a service time, a driving direction, and/or an order acceptance rate of the candidate service provider, or the like, or any combination thereof. More descriptions regarding the determination of the possibility may be found elsewhere in the present disclosure. See, e.g., operation 520, FIG. 6 and the relevant descriptions thereof.

The transmission module 403 may transmit, to the target requester terminal, the ETA of the potential service order for display. The ETA of the potential service order may be displayed on the target requester terminal in a form of voice, text, graph, image, or the like, or any combination thereof.

The processing engine 112B may include an obtaining module 404, a training module 405, and a testing module 406. The modules may be hardware circuits of all or part of the processing engine 1126. The modules may also be implemented as an application or set of instructions read and executed by the processing engine 112B. Further, the modules may be any combination of the hardware circuits and the application/instructions. For example, the modules may be the part of the processing engine 112B when the processing engine 112B is executing the application/set of instructions.

The obtaining module 404 may be configured to obtain information used to generate the trained neural network model of ETA. For example, the obtaining module 404 may obtain information related to a sample potential service order, such as third information related to the sample potential service order, fourth information related to one or more sample candidate service providers within a sample threshold distance from the corresponding sample start location, sample demand information related to one or more sample potential requester terminals within the sample threshold distance from the corresponding sample start location, a preliminary neural network model, an actual time of arrival (ATA) of the sample potential service order, or the like, or any combination thereof. In some embodiments, the obtaining module 404 may obtain information from one or more components of the O2O service system 100, such as the storage device 160, the requester terminal 130, and/or the provider terminal 140. Additionally or alternatively, the obtaining module 404 may obtain information from an external data source (not shown) via the network 120.

The training module 405 may be configured to generate the trained neural network model of ETA by training the preliminary neural network model. In some embodiments, the training module 405 may train the preliminary neural network model by determining a loss function, which is a difference between predicted ETAs and ATAs of a plurality of sample potential service orders or a first portion of the sample potential service orders. More descriptions regarding the training of the preliminary neural network model can be found elsewhere in the present disclosure. See, e.g., operations 703 and 707, and the relevant descriptions.

The testing module 406 may be configured to test the trained preliminary neural network model by determining a test parameter. In some embodiments, the test parameter may be determined based on the trained preliminary neural network model and a second portion of the sample potential service orders. More descriptions regarding the test parameter can be found elsewhere in the present disclosure. See, e.g., operations 708, 709 and the relevant descriptions.

It should be noted that the above description of the processing engines 112A and 112B is provided for the purposes of illustration, and is not intended to limit the scope of the present disclosure. For persons having ordinary skills in the art, multiple variations and modifications may be made under the teachings of the present disclosure. However, those variations and modifications do not depart from the scope of the present disclosure. In some embodiments, any module mentioned above may be divided into two or more units. For example, the obtaining module 401 may be divided into a first obtaining unit configured obtain first information related to a potential service order and a second obtaining unit configured to obtain second information related to one or more candidate service providers within the threshold distance from a start location of the potential service order. Additionally or alternatively, the obtaining module 401 may include a third obtaining unit configured to obtain demand information related to one or more potential requester terminals within the threshold distance from the start location, and/or input the demand information into the trained neural network model of ETA.

In some embodiments, the processing engines 112A and/or 112B may further include one or more additional modules or one or more above mentioned modules may be omitted. For example, the processing engine 112A may further include a training module similar to the training module 405. In some embodiments, the training module may include a fourth obtaining unit configured to obtain the third and fourth information related to a plurality of sample potential service orders, and a training unit configured to train the trained neural network model of ETA. Additionally or alternatively, the training module 405 may include a fifth obtaining unit configured to obtain ATAs of the sample potential service orders and a test unit configured to test a model. In some embodiments, the processing engines 112A and the processing engine 112B may be integrated into a single processing engine 112.

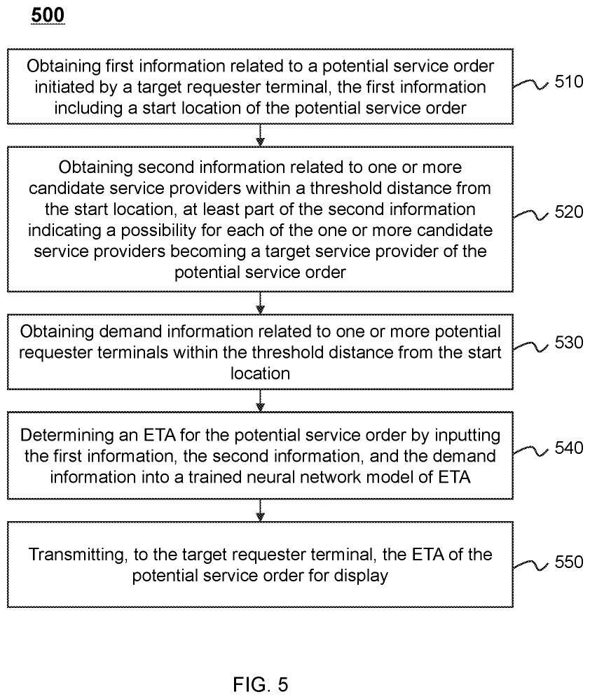

FIG. 5 is a flowchart illustrating an exemplary process for determining an ETA for O2O services according to some embodiments of the present disclosure. Process 500 may be executed by the O2O service system 100. For example, the process 500 may be implemented as a set of instructions (e.g., an application) stored in the storage device 160. In some embodiments, the processing engine 112A may execute the set of instructions and may accordingly be directed to perform the process 500 in an O2O service platform. The platform may be an Internet-based platform that connects service providers and requesters through the Internet.

In 510, the processing engine 112A (e.g., the obtaining module 401) may obtain first information related to a potential service order initiated by a target requester terminal.

The potential service order may refer to a service order with a known start location but has not been formally placed by a requester of the target requester terminal. As used herein, if the request for a service order has not been made or sent to the server 110 of O2O service system 100 by the requester via the target requester terminal, the service order may be regarded as not being formally placed by the requester. For example, the requester, when intending to make a request for an O2O service, may input a start location or use a start location provided by the target requester terminal, but has not made the request. The service order in such cases may be regarded as a potential service order.

In some embodiments, after the start location is determined and before the request is made by the requester, the target requester terminal may send the potential service order to the server 110. Additionally or alternatively, the target requester terminal may continuously or periodically transmit information related to the target requester terminal to the server 110. The server 110 (e.g., the processing engine 112A) may determine whether there is a potential service order initiated by the requester via the target requester terminal according to the received information. In response to the received or determined potential service order, the processing engine 112A may perform the process 500 to determine an estimated time for a target service provider to arrive at the start location of the potential service order, which is referred to as an ETA of the potential service order for brevity.

In some embodiments, the potential service order may be a service order related to an O2O service. Exemplary O2O services may include a transportation service (for example, a taxi hailing service, a chauffeur service, an express car service, a carpool service, a bus service, a driver hire service, and a shuttle service), a post service, a food order service, a take-away service, or the like, or any combination thereof. The target requester terminal may be a requester terminal 130 via which the requester makes a request for the O2O service.

The first information may include any information related to the potential service order. Exemplary first information may include but be not limited to time information, location information, weather information, traffic information, policy information, news information, user information, or the like, or any combination thereof. The time information may include a request time, a request date, a specific date section (e.g., a weekday, a weekend, a holiday, a festival) of the request time, a time interval (e.g., in the rush hour, in daytime, at evening) of the request time, or the like, or any combination thereof. The location information may include a current location of the requester, a start location and/or a destination of the potential service order, a density of buildings around the start location and/or the destination, a route from the start location to the destination, or the like, or any combination thereof. The weather information may include an index of air quality, a temperature, a visibility, a humidity, a pressure, a wind speed, an index of PM 2.5, an amount of precipitation, a type of precipitation (e.g., snow, rain), a percentage likelihood of precipitation, or the like, or any combination thereof. The weather information may include, for example, real-time weather information, substantially real-time weather information, and/or weather forecast information. The traffic information may include a traffic volume, a traffic congestion condition, a number of traffic accidents and their locations, a vehicle speed (e.g., an average speed, an instantaneous speed) information around the start location and/or the destination, or along the route from the start location to the destination of the potential service order, or the like, or any combination thereof. The policy information may include laws and rules related to traffic, to vehicle management (e.g., only vehicles with certain plate numbers (e.g., even or odd) can be driven in certain areas), to speed limits, or the like, or any combination thereof. The news information may include information and/or a number of events (e.g., a concert, an exhibition, a competition, a market promotion) around the start location and/or the destination of the potential service order. The user information may include preference information, profile information (e.g., gender, age, education level, occupation, birthplace, residence), performance information (e.g., a performance score evaluated by service providers) of the requester of the potential service order, or the like, or any combination thereof.

In some embodiments, the first information may be obtained from one or more components of the O2O service system 100, for example, the target requester terminal 130, the storage device 160, the processing engine 112A. Additionally or alternatively, at least part or all of the first information may be obtained from an external source via the network 120. For example, the weather information may be obtained from a weather forecast database or website.

In some embodiments, the first information related to the potential service order may at least include the start location of the potential service order. The start location of the potential service order may refer to a location where the requester of the target requester terminal wants and/or needs to receive an O2O service. In some embodiments, the requester of the target requester terminal may initiate a service request for himself/herself or another user. While the embodiments of the present invention, with minor modifications known by a person skilled in the art, can be applied to the request-service-for-others scenario, the descriptions hereinafter use the request-service-for-self scenario as examples.

In some embodiments, the start location of the potential service order may be a current location of the target requester terminal. For example, the current location of the target requester terminal may be set as the start location when a requester opens or uses an application for the O2O service installed on the target requester terminal. The current location of the target requester terminal may be determined based on a positioning technology, such as but not limited to, a GPS positioning technology, a base station positioning technology, a WIFI positioning technology, etc. In some embodiments, the current location of the target requester terminal may be automatically transmitted to the obtaining module 401 by the target requester terminal.

Additionally or alternatively, the start location may be inputted by the requester via the target requester terminal and then transmitted to the obtaining module 401. The requester may input the start location by way of typing, writing, using his/her voice, making a gesture, touching an interface of the target requester terminal, or the like, or any combination thereof. For example, the requester may input the start location by touching a screen of the target requester terminal. Merely for illustration purposes, the target requester terminal may display a map on which the start location is marked by a pin, and the requester may move the start location by dragging the pin on the map. The moved start location may be set as the start location.

In 520, the processing engine 112A (e.g., the obtaining module 401) may obtain second information related to one or more candidate service providers within a threshold distance from the start location of the potential service order. At least part of the second information may indicate a possibility for each of the one or more candidate service providers becoming a target service provider of the potential service order.

A candidate service provider may be any service provider who is within the threshold distance from the start location and available or about to be available to accept the potential service order. For example, a candidate service provider may be a service provider who is within the threshold distance from the start location and waiting for a service order. As another example, a candidate service provider may be a service provider who is within the threshold distance from the start location and in the process of providing service, but will finish the last service order within a certain period, such as 0.5 minutes, 1 minute. As yet another example, a candidate service provider may be a service provider who is within the threshold distance from the start location and serving another requester, but can accept the potential service order at the same time. For some kinds of O2O services, such as but not limited to a carpooling service, a delivery service, and a take-way service, a service provider may simultaneously provide services for a plurality of service requesters. For example, a delivery man, in the process of delivering goods, may accept a new service order if the start location of the new service order is on his/her way of delivering.

The threshold distance may have any positive value, such as but not limited to 50 m, 100 m, or 1 km, or the like. The threshold distance may be a default parameter stored in a storage device (e.g., the storage device 160) or be set by a user of the O2O service system 100. In some embodiments, the threshold may be determined by one or more components in the O2O service system 100, such as but not limited to the processing engine 112A. In some embodiments, the threshold distance may vary with different situations, such as different request time, different service areas, different weather, etc. Merely by way of example, the threshold distance corresponding to a start location in city may be smaller than that corresponding to a start location in district.

For each candidate service provider, the second information may include but be not limited to vehicle information, capacity information, price information, service information, location information, or performance information, or any combination thereof. The vehicle information and the capacity information may be related to a vehicle that a candidate service provider uses in providing services. The vehicle information may include a vehicle type, a brand of the vehicle, the age of the vehicle, or the like, or any combination thereof. The capacity information may include the number of seats in the vehicle, a load capacity (e.g., a weight of products that the vehicle can carry) of the vehicle, or the like, or any combination thereof. The price information may include a fundamental price for a candidate service provider to provide services, a unit price (e.g., a price per unit distance), a dynamitic price rate, or the like, or any combination thereof. The service information may include an order acceptance rate, an order completion rate, an order cancellation rate, a service response time, the number of historical service orders of the candidate service provider, or the like, or any combination thereof. The location information may include a current location of the candidate service provider, a distance between the candidate service provider and the start location of the potential service order, a number of crossroads along the route between the candidate service provider and the start location, or the like, or any combination thereof. The distance between the candidate service provider and the start location may be a linear distance or distance of the route between them. The performance information may include a performance score evaluated by requesters, a number of complaints received from requesters, or the like, or any combination thereof.

In some embodiments, at least part of the second information may indicate a possibility for each candidate service provider becoming a target service provider of the potential service order. As used herein, a target service provider may refer to a service provider who accepts the potential service order. In the O2O service system 100, it is possible that a candidate service provider of the potential service order A may become a target service provider of a potential service order B, for example, when the candidate service provider is closer to the start location of the potential service order B. In such case, without considering the possibility for each candidate service provider becoming a target service provider of the potential service order, the ETA of the potential service order may not be determined precisely and accurately. The current invention provides methods and systems to provide more precise and accurate determination of ETA by taking the possibility for each candidate service provider becoming a target requester terminal of the potential service order into consideration.

The possibility for a candidate service provider becoming a target service provider of the potential service order may be affected by various factors, such as a supply and demand relationship in the nearby area around the start location of the potential service order, the traffic rules and laws in the nearby area around the start location and/or the destination, a service region, a service time, a driving direction, and/or an order acceptance rate of the candidate service provider, or the like, or any combination thereof.

The nearby area around the start location or destination may be any regular or irregular area surrounding the start location or destination. The supply and demand relationship in an area may be determined by the number of candidate service providers and the number of service orders (e.g., potential service orders and/or service orders that has been made by requesters) in the area. For example, if the number of service orders is more than the number of the candidate service providers in an area, the area may be in short supply. The traffic rules and laws may be related to traffic, vehicle management (e.g., only vehicles with certain plate numbers (e.g., even or odd) can be driven in certain areas), to speed limits, or the like.

In some embodiments, the processing engine 112A (e.g., the determination module 402) may determine the possibility for each candidate service provider by taking one or more of the above mentioned factors into consideration. For example, when the nearby area of the start location of the potential service order is in short supply, the determination module 402 may assign a relatively lower possibility for a candidate service provider than that when the nearby area is in sufficient supply. As another example, when the destination of the potential service order is out of the service region of a candidate service provider, the determination module 402 may set the possibility of the candidate service provider as 0. As a further example, if the plate number of a candidate service provider is restricted in the nearby area around the destination, the determination module 402 may set the possibility of candidate service provider as 0. In some embodiments, the determination module 402 may determine the possibility for each candidate service provider by performing one or more operations of process 600 as will described in connection with FIG. 6.

In 530, the processing engine 112A (e.g., the obtaining module 401) may obtain demand information related to one or more potential requester terminals within the threshold distance from the start location.

A potential requester terminal may refer to a requester terminal 130 that is located within the threshold distance from the start location of the potential service order and initiates another potential service order during a predetermined period. As described in connection with 520, the supply and demand relationship in the nearby area of the start location of the potential service order may need to be considered in the determination of the ETA of the potential service order, in order to determine a more precise and accurate ETA. The supply for the O2O service in the nearby area of the start location may be reflected by the second information related to the candidate service provider(s) within the threshold distance from the start location, as obtained in 520. The demand for the O2O service in the nearby area of the start location may be reflected by the demand information related to the potential requester terminal(s) within the threshold distance from the start location.

The predetermined period may be any period including a first period before the potential service order is initiated by the target requester terminal and/or a second period after the potential service order is initiated by the target requester terminal. The first period and/or the second period may have any duration, such as but not limited to 30 seconds, 1 minute, 2 minutes, 3 minutes, or the like. The first period and the second period may have the same duration or different durations. In some embodiments, the threshold distance for defining the potential requester terminal(s) in 530 may be same as or different from that for defining the candidate service provider(s) in 520.

In some embodiments, the demand information may include information related to each potential requester terminal, the number of potential requester terminals corresponding to the potential service order, the distance between each potential requester terminal and each candidate service provider of the potential service order, or the like, or any combination thereof. In some embodiments, the information related to a potential requester terminal may include information related to a potential service order that is initiated by the potential requester terminal, which is similar to the first information related to a potential service order initiated the target requester terminal as described in connection with 510.

In some embodiments, the obtaining module 401 may obtain demand information related to all or a selected group of the potential requester terminal(s) within the threshold distance from the start location. For example, because a requester of a potential service order may not always make a formal request, the obtaining module 401 may only obtain demand information of a certain percentage of potential requester terminal(s) within the threshold distance from the start location. The certain percentage may be a default parameter stored in a storage device (e.g., the storage device 160), be set by a user of the O2O service system 100, or be determined by the processing engine 112A.

In 540, the processing engine 112A (e.g., the determination module 402) may determine an ETA for the potential service order by inputting the first information, the second information, and the demand information into a trained neural network model of ETA.

The trained neural network model of ETA may be configured to determine an ETA of the potential service order based on the input (e.g., the first information, the second information, and/or the demand information). In some embodiments, the trained neural network model of ETA may be acquired by the obtaining module 401 from a storage device in the O2O system 100 (e.g., the storage device 160) and/or an external data source (not shown) via the network 120.

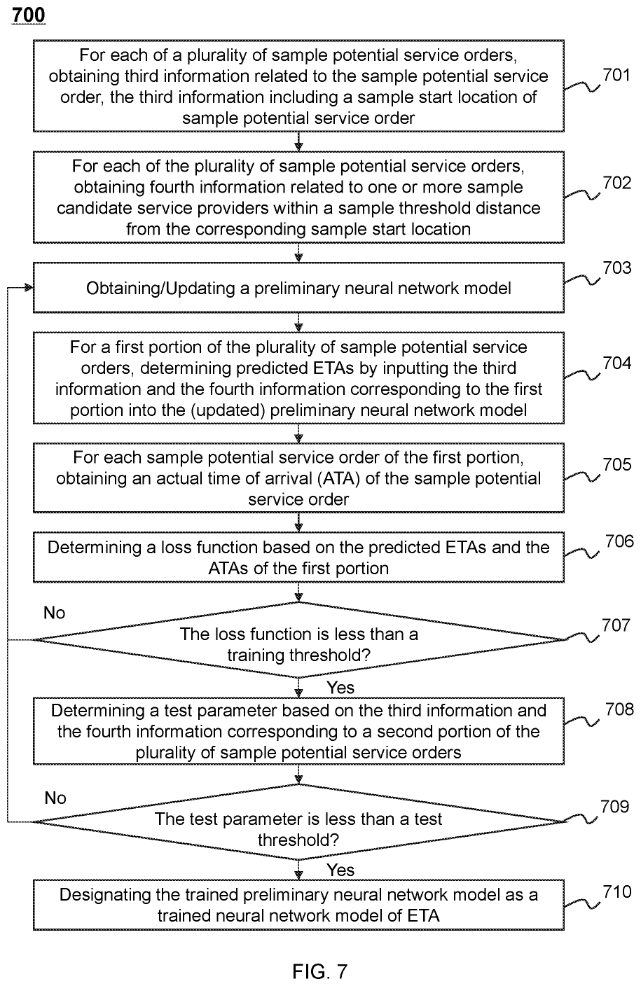

In some embodiments, the processing engine 112B (e.g., the training module 405) may generate the trained neural network model of ETA, and store it in the storage device. The obtaining module 401 may access the storage device and retrieve the trained neural network model of ETA. In some embodiments, the processing engine 112B may generate the trained neural network model of ETA based on a machine learning method. The machine learning method may include but not be limited to an artificial neural networks algorithm, a deep learning algorithm, a decision tree algorithm, an association rule algorithm, an inductive logic programming algorithm, a support vector machines algorithm, a clustering algorithm, a Bayesian networks algorithm, a reinforcement learning algorithm, a representation learning algorithm, a similarity and metric learning algorithm, a sparse dictionary learning algorithm, a genetic algorithms, a rule-based machine learning algorithm, or the like, or any combination thereof. In some embodiments, the processing engine 112B may determine the trained neural network model of ETA by performing one or more operations in process 700 illustrated in FIG. 7.

In 550, the processing engine 112A (e.g., the transmission module 403) may transmit, to the target requester terminal, the ETA of the potential service order for display.

The ETA of the potential service order may be displayed on the target requester terminal in a form of voice, text, graph, image, or the like, or any combination thereof. For example, the ETA of the potential service order may be displayed as a text, such as “1 minute”, “2 minutes”, “five minutes”, on an interface of the target requester terminal. As another example, the ETA of the potential service order may be broadcasted by the target requester terminal. In some embodiments, the ETA of the potential service order may be displayed on or by an APP for O2O service installed in the target requester terminal.

It should be noted that the above description regarding the process 500 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

For example, one or more additional optional operations may be added and/or one or more the above mentioned operations may be omitted. For example, operation 530 may be omitted. In 540, the determination module 402 may determine the ETA by inputting the first and second information into the trained neural network model of ETA. In some embodiments, the order of the operations in the process 500 may be changed. For example, operations 510 to 530 may be performed simultaneously or in any order. In some embodiments, an operation in process 500 may be divided into a plurality of sub-operations. Merely by way of example, operation 540 may be divided into a first sub-operation in which the training module 405 generates the trained neural network model of ETA and a second sub-operation in which the determination module 402 determine the ETA of the potential service order by inputting the first, second, and/or the demand information into the trained neural network model of ETA.

FIG. 6 is a flowchart illustrating an exemplary process for determining a possibility for a candidate service provider becoming a target service provider of a potential service order according to some embodiments of the present disclosure. Process 600 may be executed by the O2O service system 100. For example, the process 600 may be implemented as a set of instructions (e.g., an application) stored in storage device 160. In some embodiments, the processing engine 112A may execute the set of instructions and may accordingly be directed to perform the process 600 in an O2O service platform. The platform may be an Internet-based platform that connects service providers and requesters through the Internet. In some embodiments, the process 600 may be performed to achieve at least part of operation 520 with reference to FIG. 5.

In 610, the processing engine 112A (e.g., the determination module 402) may determine the one or more candidate service providers within the threshold distance from the start location of the potential service order.

As described in connection with operation 520, a candidate service provider of the potential service order may be any service provider who is within the threshold distance from the start location of the potential service order and available or about to be available to accept the potential service order. In the O2O service system 100, a service provider terminal 140 may continuously or periodically transmit information (e.g., positioning information and/or the availability status) to the server 110 via the network 120. Based on the received information of all or part of the service provider terminals 140 in the O2O service system 100, the server 110 (e.g., the processing engine 112A) may determine the candidate service provider(s) among the all or part of the service provider terminals 140.

Merely by way of example, for a service provider terminal 140, the processing engine 112A may determine whether the service provider terminal 140 is located within the threshold distance from the start location. In response to the determination that the service provider terminal 140 is located within the threshold distance from the start location, the processing engine 112A may further determine whether the service provider terminal 140 can accept the potential service order. In response to the determination that the service provider terminal 140 can accept the potential service order, the service provider terminal 140 may be designated as one of the candidate service provider(s).

In 620, the processing engine 112A (e.g., the determination module 402) may determine one or more potential requester terminals within the threshold distance from the start location.

As described in connection with operation 530, a potential requester terminal may refer to a service requester terminal 130 that is located within the threshold distance from the start location of the potential service order and initiates another potential service order during a predetermined period. In the O2O service system 100, a service requester terminal 130 may continuously or periodically transmit information (e.g., positioning information and/or request information) related to the potential requester terminals to the server 110 via the network 120. Based on the received information of all or part of the service requester terminals 130 in the O2O service system 100, the server 110 (e.g., the processing engine 112A) may determine the potential requester terminal(s) among the all or part of the service requester terminal 130.

Merely by way of example, for a service requester terminal 130, the processing engine 112A may determine whether the service requester terminal 130 is located within the threshold distance from the start location. In response to the determination that the service requester terminal 130 is located within the threshold distance from the start location, the processing engine 112A may further determine whether the service requester terminal 130 initiates a potential service order during the predetermined period. In response to the determination that the service requester terminal 130 initiates a potential service order during the predetermined period, the service requester terminal 130 may be designated as one of the potential requester terminal(s).

In 630, the processing engine 112A (e.g., the determination module 402) may pre-allocate the candidate service provider(s) to the one or more potential requester terminals and the target requester terminal.

In some embodiments, the pre-allocation may be performed based on a distance from each candidate service provider to each potential requester terminal or the target requester terminal, a distance from each candidate service provider to a start location of a potential service order initiated by each potential requester terminal or the target requester terminal, an estimated time for the each candidate service provider to get to each potential requester terminal or the target requester terminal, an estimated time for the each candidate service provider to get to a start location of a potential service order initiated by each potential requester terminal or the target requester terminal, the preference of the requester of each potential requester terminal and the target requester terminal, or the like, or any combination thereof. Merely by way of example, the pre-allocation may be performed based on the distance from each candidate service provider to each potential requester terminal or the target requester terminal. A distance between a candidate service provider and a potential or target requester terminal may be a linear distance or a route distance between them. In some embodiments, a candidate service provider may be allocated to a potential or target requester terminal that is closest to the candidate service provider.

In 640, the processing engine 112A (e.g., the determination module 402) may determine, based on the pre-allocation result, the possibility for each candidate service provider becoming the target service provider of the potential service order.

In some embodiments, the determination module 402 may assign a possibility to a candidate service provider according to the service requester terminal that the candidate service provider is pre-allocated to. For example, for a candidate service provider A who is pre-allocated to a potential requester terminal, the corresponding possibility may be set as a first value. For a candidate service provider B who is pre-allocated to the target requester terminal, the corresponding possibility may be set as a second value. The first value may be smaller than the second value, indicating that B is more likely to become the target requester terminal than A. In some embodiments, the first values assigned to different candidate service providers who are pre-allocated to a potential requester terminal may be the same or different. The second values assigned to different candidate service providers who are pre-allocated to the target requester terminal may be the same or different. For example, the candidate service provides pre-allocated to the target requester terminal may be assigned different second values of possibilities depending on their distances to the start location of the potential service order initiated by the target requester terminal.

In some embodiments, the determination module 402 may determine the possibility corresponding to each candidate service provider according to the pre-allocation result as well as one or more other factors that may affect the possibility, such as the traffic rules and laws in the nearby area around the start location and/or the destination of the potential service order, a service region, a service time, a driving direction, and/or an order acceptance rate of the candidate service provider, or the like, or any combination thereof. For example, if a candidate service provider is pre-allocated to the target requester terminal but the destination of the potential service order is out of the service region of the candidate service provider, the determination module 402 may determine the possibility of the candidate service provider as 0. As another example, if a candidate service provider is pre-allocated to the target requester terminal and the destination of the potential service order is along the driving direction of the candidate service provider, the determination module 402 may set the possibility of the candidate service provider as a higher value than the second value. As yet another example, if a candidate service provider is pre-allocated to the target requester terminal but an order acceptance rate of the candidate service provider is low, the determination module 402 may set the possibility of the candidate service provider as a lower value than the second value.

It should be noted that the above descriptions of the process 600 are provided for the purposes of illustration, and not intended to limit the scope of the present disclosure. For persons having ordinary skills in the art, various modifications and changes in the forms and details of the application of the above method and system may occur without departing from the principles in the present disclosure. However, those variations and modifications also fall within the scope of the present disclosure. For example, operations 610 and 620 may be performed simultaneously or operation 620 may be performed before 610. As another example, the threshold distance for defining candidate service provider(s) in operation 610 may be different from that for defining potential service order(s) in operation 620.

FIG. 7 is a flowchart illustrating an exemplary process for determining a trained neural network model of ETA according to some embodiments of the present disclosure. Process 700 may be executed by the O2O service system 100. For example, the process 700 may be implemented as a set of instructions (e.g., an application) stored in storage device 160. In some embodiments, the processing engine 112B may execute the set of instructions and may accordingly be directed to perform the process 700 in an O2O service platform. The platform may be an Internet-based platform that connects O2O service providers and requesters through the Internet. In some embodiments, the trained neural network model of ETA may be used to determine an ETA of a potential service order as described in connection with FIG. 5.

In 701, the processing engine 112B (e.g., the obtaining module 404) may obtain third information related to each of a plurality of sample potential service orders. The third information related to a sample potential service order may include a sample start location of the sample potential service order

A sample potential service order may be a historical potential service order that has been completed. As used herein, if a historical potential service order was formally placed by a service requester and accepted by a service provider, and the service provider arrived at the start location of the historical potential service order to serve the service requester, the historical potential service order may be regarded as having been completed. Such historical potential service order may have a known actual time for the service provider to arrival at the start location of the historical potential service order, and can be used as a sample potential service order in model training. For brevity, the actual time for the service provider to arrival at the start location of the historical potential service order may be referred to as an actual time of arrival (ATA) of the historical potential service order.

The third information may include any information related to a sample potential service order, such as time information, location information, weather information, traffic information, policy information, news information, service order information, user information, or the like, or any combination thereof. A sample start location of a sample potential service order may refer to a location where the requester of the sample potential service order wants and/or needs to receive an O2O service. The third information and the sample start location of a sample potential service order may be respectively similar to the first information and the start location of a potential service order as described in connection with 510, and the descriptions thereof are not repeated.

In 702, for each of the plurality of sample potential service orders, the processing engine 112B (e.g., the obtaining module 404) may obtain fourth information related to one or more sample candidate service providers within a sample threshold distance from the corresponding sample start location. At least part of the fourth information may indicate a sample possibility for each of the one or more sample candidate service providers becoming a sample target service provider of the sample potential service order.

A sample candidate service provider of a sample potential service order may refer to any service provider who is within the sample threshold distance from the corresponding sample start location and available or about to be available to accept the sample potential service order. The fourth information related to a sample candidate service provider may include but be not limited to vehicle information, capacity information, price information, service information, location information, or performance information of the sample candidate service provider, or any combination thereof. The sample candidate service provider and the fourth information may be respectively similar to the candidate service provider and the second information as described in connection with 520, and the descriptions thereof are not repeated. The sample threshold distance may have any positive value, such as but not limited to 50 m, 100 m, or 1 km, or the like. The sample threshold distance may be a default parameter stored in a storage device (e.g., the storage device 160) or be set by a user of the O2O service system 100. The sample threshold distance for defining the sample candidate service provider(s) may be same as or different from that for defining the candidate service provider(s) in FIG. 5.

In 703, the processing engine 112B (e.g., the obtaining module 404) may obtain a preliminary neural network model.

In some embodiments, the preliminary neural network model may have default settings (e.g., one or more preliminary parameters) determined by the O2O service system 100 or may be adjustable in different situations. In some embodiments, the preliminary neural network model may include but not be limited to a convolutional neural network (CNN) model, an artificial neural network (ANN) model, a recurrent neural network (RNN) model, a deep trust network model, a perceptron neural network model, a stack self-coding network model, or any other suitable neural network model.

In some embodiments, to generate the trained neural network model of ETA using the sample potential service orders, a first portion and a second portion of sample potential service orders may be selected from the sample potential service orders. The first portion of the sample potential service orders (referred to as the first portion for brevity) may be applied in training the preliminary neural network model. The second portion of the sample potential service orders (referred to as the second portion for brevity) may be applied in testing the trained preliminary neural network model. The first portion may be a first percentage, such as 50%, 60%, 70%, 80% or 90% of the sample potential service orders. The second portion may be a second percentage, such 50%, 60%, 70%, 80% or 90% of the sample potential service orders. The first and second percentages may the same or different. The first portion and the second portion may overlap or not. In some embodiments, the first portion may also be referred to as a training set and the second portion may also be referred to as a testing set.

In 704, for each sample potential service order of the first portion, the processing engine 112B (e.g., the training module 405) may determine a predicted ETA by inputting the third information and the fourth information of the sample potential service order into the preliminary neural network model.

In 705, for each sample potential service order of the first portion the processing engine 112B (e.g., the obtaining module 404) may obtain an ATA of the sample potential service order. In some embodiments, the obtaining module 404 may obtain an ATA of a sample potential service order from a storage device (e.g., a storage device 160, a storage 390, or a storage module not shown in FIG. 4).

In 706, the processing engine 112B (e.g., the training module 405) may determine a loss function based on the predicted ETAs and the ATAs of the first portion of sample potential service orders. The loss function may indicate an accuracy of the preliminary neural network model. In some embodiments, the training module 405 may determine the loss function based on differences between the predicted ETAs and the ATAs of the first portion. In some embodiments, a difference between a predicted ETA and an ATA of a sample potential service order may be determined based on an algorithm including, for example, a mean absolute percent error (MAPE), a mean squared error (MSE), a root mean square error (RMSE), or the like, or any combination thereof.

In 707, the processing engine 112B (e.g., the training module 405) may determine whether the loss function (e.g., the differences between the predicted ETAs and the ATAs of the first portion) is less than a training threshold. The training threshold may be default settings in the O2O service system 100 or may be adjustable in different situations.

In response to a determination that the value of the loss function is less than the training threshold, the processing engine 112B may designate the preliminary model as a trained preliminary model, and execute the process 700 to 708.

On the other hand, in some embodiments, in response to a determination that the value of the loss function is larger than or equal to the training threshold, the processing engine 1126 may execute the process 700 to return to 703 to update the preliminary neural network model until the loss function is less than the training threshold. For example, the processing engine 112B may update the plurality of preliminary parameters (e.g., a weight corresponding to information used in model training). Further, in some embodiments, if the processing engine 112B determines that under the updated parameters, the value of the loss function is less than the training threshold, the processing engine 112B may designate the updated preliminary neural network model as a trained preliminary neural network model, and execute the process to 708. On the other hand, if the processing engine 1126 determines that under the updated parameters, the value of the loss function is larger than or equal to the training threshold, the processing engine 112B may still execute the process 700 to return to 703 to further update the parameters. The iteration from operations 703 through 707 may continue until the processing engine 112B determines that under newly updated parameters the value of the loss function is less than the training threshold, and the processing engine 112B may execute the process 700 to 708.

In 708, the processing engine 112 (e.g., the testing module 406) may determine a test parameter of the trained preliminary neural network model based on the third information and the fourth information corresponding to the second portion of the sample potential service orders. The test parameter may be used to test the accuracy of the trained preliminary neural network model. In some embodiments, the test parameter may include but be not limited to a precision, a recall, an F-score, a confusion matrix, a Receiver Operating Characteristic (ROC), Area under Curve (AUC), a variance, or the like. In some embodiments, the test parameter may be determined based on differences between ATAs and ETAs of the second portion. The ATAs and ETAs of the second portion may be determined or obtained in a similar way to that of the first portion.

In 709, the processing engine 112B (e.g., the training module 405) may determine whether the test parameter is less than a test threshold. The test threshold may be default settings in the O2O service system 100 or may be adjustable in different situations.

In response to a determination that the test parameter is less than the test threshold, the processing engine 112B may designate the trained preliminary neural network model as a trained neural network model of ETA in 710. In some embodiments, the processing engine 112B may save the trained neural network model in a storage medium (e.g., a storage device 160) in forms as structured data. The structured data of the trained neural network model may be constructed or retrieved by the processing engine 112B based on a B-tree or a hash table. In some embodiments, the structured data may be stored or saved as a form of a data library in the storage device.

On the other hand, in some embodiments, in response to a determination that the test parameter is not less than the test threshold, the processing engine 112B may direct the process 700 to return to 703 to re-train the (trained) preliminary neural network model until the test parameter is less than the test threshold. For example, the processing engine 112B may further update the parameters of the (trained) preliminary neural network model. As another example, the processing engine 112 may obtain a different type of the preliminary neural network model for training. In some embodiments, in response to a determination that the test parameter is not less than the test threshold, the processing engine 112B may direct the process 700 to return to 704 and direct operations 704 to 707 to train the (updated) preliminary neural network model using another re-obtained first portion of the sample potential service orders.

The iteration from operations 703 through 707 may continue until the processing engine 112B determines that the loss function based on the first portion (or the re-obtained first portion) is less than the training threshold, and the processing engine 112B may direct the process 700 to 708. In 708, the processing engine 112B may determine a test parameter to test the newly trained preliminary neural network model based on the third and fourth information corresponding to the original second portion or another re-obtained second portion.

The iteration from operations 703 through 709 may continue until the processing engine 112B determines that under newly trained preliminary neural network model, the test parameter is less than the test threshold, and the processing engine 112B may designate the newly trained preliminary neural network model as the trained neural network model of ETA.

It should be noted that the above description of the process 700 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be integrated into one operation. For example, operations 704 to 707 may be integrated into an operation in which the processing engine 112B (e.g., the training module 405) trains the preliminary neural network model using the third and fourth information corresponding to a first portion of sample potential service orders. As another example, operations 708 and 709 may be integrated into an operation in which the processing engine 112B (e.g., the testing module 406) may test the trained preliminary neural network model using the third and fourth information corresponding to a second portion of sample potential service orders by determining a test parameter. In some embodiments, the order of the operations in process 700 may be changed. For example, operations 701 to 703 may be performed simultaneously or in any order. As another example, operations 704 and 705 may be performed simultaneously or in any order.

In some embodiments, one or more additional operations may be added and/or one or more operations mentioned above may be omitted. For example, the trained neural network model of ETA may be further evaluated after operation 710. As another example, before operation 704, for each of the sample potential service orders, the processing engine 112B (e.g., the obtaining module 404) may obtain sample demand information related to one or more sample potential requester terminals within the sample threshold distance from the corresponding sample start location. The sample potential requester terminals and the sample demand information corresponding to a sample potential service order may be similar to the potential requester terminal and the demand information corresponding to a potential service order as described in FIG. 5. The processing engine 112B may train the preliminary neural network model by the third information, the fourth information, and the sample demand information corresponding to a first portion of the sample potential service orders. The processing engine 1126 may also test the trained preliminary neural network model using the third information, the fourth information, and the demand information corresponding to a second portion of the sample potential service orders. In some embodiments, operations 708 and 709 may be omitted. The training module 405 may train the preliminary neural network model using the sample potential service orders and the trained preliminary neural network model may be designated as the trained neural network model of ETA.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 1703, Perl, COBOL 1702, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system for determining an estimated time of arrival (ETA) for Online to Offline (O2O) services, comprising:
at least one non-transitory computer-readable storage medium including a set of instructions;
at least one processor in communication with the at least one non-transitory computer-readable storage medium, wherein when executing the instructions, the at least one processor is directed to cause the system to:
obtain first information related to a potential service order initiated by a target requester terminal, the first information including a start location of the potential service order;
obtain second information related to one or more candidate service providers within a threshold distance from the start location, at least part of the second information indicating a possibility for each of the one or more candidate service providers becoming a target service provider of the potential service order;
determine an ETA for the potential service order by inputting the first information and the second information into a trained neural network model of ETA; and
transmit, to the target requester terminal, the ETA of the potential service order for display.

2. The system of claim 1, wherein to obtain the second information related to the one or more candidate service providers, the at least one processor is further directed to cause the system to:
determine the one or more candidate service providers within the threshold distance from the start location;
determine one or more potential requester terminals within the threshold distance from the start location;
pre-allocate the one or more candidate service providers to the one or more potential requester terminals and the target requester terminal; and
determine, based on the pre-allocation result, the possibility for each of the one or more candidate service providers becoming the target service provider of the potential service order.

3. The system of claim 1, wherein to determine the ETA for the potential service order, the at least one processor is further directed to cause the system to:
obtain demand information related to one or more potential requester terminals within the threshold distance from the start location; and
determine the ETA for the potential service order by inputting the first information, the second information, and the demand information into the trained neural network model of ETA.

4. The system of claim 3, wherein the demand information comprises at least one of time information, location information, service order information, or user information related to the one or more potential requester terminals.

5. The system of claim 1, wherein the first information further comprises at least one of time information, location information, weather information, traffic information, policy information, news information, or user information related to the potential service order.

6. The system of claim 1, wherein the second information further comprises at least one of vehicle information, capacity information, price information, service information, location information, or performance information related to the one or more candidate service providers.

7. The system of claim 1, wherein the trained neural network model of ETA is generated according to a training process, the training process comprising:
for each of a plurality of sample potential service orders, obtaining third information related to the sample potential service order, the third information including a sample start location of the sample potential service order;
for each of the plurality of sample potential service orders, obtaining fourth information related to one or more sample candidate service providers within a sample threshold distance from the corresponding sample start location, at least part of the fourth information indicating a sample possibility for each of the one or more sample candidate service providers becoming a sample target service provider of the sample potential service order;
obtaining a preliminary neural network model; and
generating the trained neural network model of ETA by training the preliminary neural network model using the third information and the fourth information of the plurality of sample potential service orders.

8. The system of claim 7, wherein the generating the trained neural network model of ETA further comprises:
for each of the plurality of sample potential service orders, obtaining sample demand information related to one or more sample potential requester terminals within the threshold distance from the corresponding sample start location; and
determining the trained neural network model of ETA by training the preliminary neural network model using the third information, the fourth information, and the sample demand information of each of the plurality of sample potential service orders.

9. The system of claim 7, wherein the determining the trained neural network model of ETA further comprises:
(1) training the preliminary neural network model by the third information and the fourth information corresponding to a first portion of the plurality of sample potential service orders;
(2) testing the trained preliminary neural network model with the third information and the fourth information corresponding to a second portion of the plurality of sample potential service orders by determining a test parameter; and
repeating steps (1)-(2) upon a determination that the test parameter is more than or equal to the test threshold, or designating the trained preliminary neural network model as the trained neural network model of ETA upon a determination that the test parameter is less than the test threshold.

10. The system of claim 9, wherein the training the preliminary neural network model by the third information and the fourth information corresponding to the first portion of the plurality of sample potential service orders comprises:
for each of the first portion of the plurality of sample potential service orders, obtaining an actual time of arrival (ATA) of the sample potential service order;
for each of the first portion of the plurality of sample potential service orders, determining a predicted ETA by inputting the third information and the fourth information of the sample potential service order into the preliminary neural network model;
determining a loss function based on the predicted ETAs and the ATAs of the first portion of sample potential service orders;
determining whether the loss function is less than a training threshold; and
designating the preliminary neural network model as the trained preliminary neural network model upon a determination that the loss function is less than the training threshold, or updating the preliminary neural network model in response to a determination that the loss function is not less than the training threshold.

11. A method for determining an estimated time of arrival (ETA) for Online to Offline (O2O) services, that is implemented on a computing device having at least one processor, at least one computer-readable storage medium, and a communication platform connected to a network, comprising:
obtaining first information related to a potential service order initiated by a target requester terminal, the first information including a start location of the potential service order;
obtaining second information related to one or more candidate service providers within a threshold distance from the start location, at least part of the second information indicating a possibility for each of the one or more candidate service providers becoming a target service provider of the potential service order;
determining an ETA for the potential service order by inputting the first information and the second information into a trained neural network model of ETA; and
transmitting, to the target requester terminal, the ETA of the potential service order for display.

12. The method of claim 11, wherein the obtaining the second information related to the one or more candidate service providers comprises:
determining the one or more candidate service providers within the threshold distance from the start location;
determining one or more potential requester terminals within the threshold distance from the start location;
pre-allocating the one or more candidate service providers to the one or more potential requester terminals and the target requester terminal; and
determining, based on the pre-allocation result, the possibility for each of the one or more candidate service providers becoming the target service provider of the potential service order.

13. The method of claim 11 or 12, wherein the determining the ETA for the potential service order comprises:
obtaining demand information related to one or more potential requester terminals within the threshold distance from the start location; and
determining the ETA for the potential service order by inputting the first information, the second information, and the demand information into the trained neural network model of ETA.

14. The method of claim 13, wherein the demand information comprises at least one of time information, location information, service order information, or user information related to the one or more potential requester terminals.

15. The method of claim 11, wherein the first information further comprises at least one of time information, location information, weather information, traffic information, policy information, news information, or user information related to the potential service order.

16. The method of claim 11, wherein the second information further comprises at least one of vehicle information, capacity information, price information, service information, location information, or performance information related to the one or more candidate service providers.

17. The method of claim 11, wherein the trained neural network model of ETA is generated according to a training process, the training process comprising:
for each of a plurality of sample potential service orders, obtaining third information related to the sample potential service order, the third information including a sample start location of the sample potential service order;
for each of the plurality of sample potential service orders, obtaining fourth information related to one or more sample candidate service providers within a sample threshold distance from the corresponding sample start location, at least part of the fourth information indicating a sample possibility for each of the one or more sample candidate service providers becoming a sample target service provider of the sample potential service order;
obtaining a preliminary neural network model; and
generating the trained neural network model of ETA by training the preliminary neural network model using the third information and the fourth information of the plurality of sample potential service orders.

18. The method of claim 17, wherein the generating the trained neural network model of ETA further comprises:
for each of the plurality of sample potential service orders, obtaining sample demand information related to one or more sample potential requester terminals within the threshold distance from the corresponding sample start location; and
determining the trained neural network model of ETA by training the preliminary neural network model using the third information, the fourth information, and the sample demand information of each of the plurality of sample potential service orders.

19. The method of claim 18, wherein the determining the trained neural network model of ETA further comprises:
(1) training the preliminary neural network model by the third information and the fourth information corresponding to a first portion of the plurality of sample potential service orders;
(2) testing the trained preliminary neural network model with the third information and the fourth information corresponding to a second portion of the plurality of sample potential service orders by determining a test parameter; and
repeating steps (1)-(2) upon a determination that the test parameter is more than or equal to the test threshold, or designating the trained preliminary neural network model as the trained neural network model of ETA upon a determination that the test parameter is less than the test threshold.

20. (canceled)

21. A non-transitory computer-readable storage medium storing instructions that, when executed by at least one processor of a system for determining an estimated time of arrival (ETA) for Online to Offline (O2O) services, cause the system to perform a method, the method comprising:
obtaining first information related to a potential service order initiated by a target requester terminal, the first information including a start location of the potential service order;
obtaining second information related to one or more candidate service providers within a threshold distance from the start location, at least part of the second information indicating a possibility for each of the one or more candidate service providers becoming a target service provider of the potential service order;
determining an ETA for the potential service order by inputting the first information and the second information into a trained neural network model of ETA; and
transmitting, to the target requester terminal, the ETA of the potential service order for display.

22. (canceled)
